(19) United States
(12) Patent Application Publication
(10) Pub. No.: US 2026/0241885 A1
(43) Pub. Date: Aug. 20, 2026

(54) AIR BAG DEVICE

(71) Applicant: HYUNDAI MOBIS CO., LTD., Seoul (KR)

(72) Inventors: Dong Gil LEE, Yongin-si (KR); Seok Hoon KO, Yongin-si (KR); Sang Won HWANGBO, Yongin-si (KR)

(73) Assignee: HYUNDAI MOBIS CO., LTD., Seoul (KR)

(21) Appl. No.: 19/348,904

(22) Filed: Oct. 3, 2025

(30) Foreign Application Priority Data
Feb. 19, 2025 (KR) 10-2025-0021688

(51) Int. Cl. B60R 21/231; B60R 21/207; B60R 21/2338

(52) U.S. Cl. CPC B60R 21/23138; B60R 21/207; B60R 21/2338; B60R 2021/23146; B60R 2021/23382

(57) ABSTRACT

An air bag device includes: a first chamber to be deployed in a shape that wraps around a first side and front of an occupant, the first chamber including a tether disposed in a vertical length direction at a part of the first chamber that wraps around the front of the occupant; and a second chamber to be deployed in a shape that wraps around a second side and the front of the occupant. A part of the second chamber that wraps around the front of the occupant overlaps with the part of the first chamber that wraps around the front of the occupant, and the second chamber includes a hanger that protrudes toward the tether at a part of the second chamber that overlaps with the first chamber and is to be caught by the tether.

### CROSS REFERENCE TO THE RELATED APPLICATION

This application claims priority from Korean Patent Application No. 10-2025-0021688 filed on February 19, 2025, Year] in the Korean Intellectual Property Office, the disclosure of which is incorporated herein by reference in its entirety.

### BACKGROUND

### 1. Field

The present disclosure relates to an air bag device configured to enable binding between chambers that wrap around the left and right sides of an occupant, thereby simplifying the airbag support structure while being capable of responding to various seat positions and various collision modes.

### Description of the Related Art

With the development of autonomous vehicles, the interior structure of vehicles is being simplified and streamlined, increasing passenger convenience and interior space of vehicles.

In addition, passenger seating forms are becoming diversified due to seat arrangements such as long slide seats that allow seats to move freely back and forth, and swivel seats that enable rear-facing.

However, as the interior structure of vehicles is simplified, the distance between interior structures of vehicles and passengers increases, which not only increases the distance between airbags and passengers, but also increases the distance between airbags and structures for supporting the corresponding airbags.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide an air bag device configured to enable binding between chambers that wrap around the left and right sides of an occupant, thereby simplifying the airbag support structure while being capable of responding to various seat positions and various collision modes.

Objects are not limited to the technical objects mentioned above, and other technical objects not mentioned will be clearly understood by those skilled in the art to which the present disclosure belongs from the description below.

In accordance with an aspect of the present disclosure, there is provided an air bag device comprising: a first chamber configured to be deployed in a shape that wraps around a first side and front of an occupant, the first chamber including a tether disposed in a vertical length direction at a part of the first chamber that wraps around the front of the occupant; and a second chamber configured to be deployed in a shape that wraps around a second side and the front of the occupant, wherein a part of the second chamber that wraps around the front of the occupant overlaps with the part of the first chamber that wraps around the front of the occupant, the second chamber including a hanger that protrudes toward the tether at a part of the second chamber that overlaps with the first chamber and is configured to be caught by the tether.

The first chamber may include: a first side part configured to be deployed forward from a first side of a seat to cover the first side of the occupant; and a first front part bent toward a front of the seat from a front end of the first side part to cover the front of the occupant. The second chamber may include: a second side part configured to be deployed forward from a second side of the seat to cover the second side of the occupant; and a second front part bent toward the front of the seat from a front end of the second side part to cover the front of the occupant while overlapping with the first front part.

The first chamber and the second chamber may be configured to be deployed at different times.

The tether and the hanger may be disposed in a plurality side by side with spacing in a left-right direction.

A tether hole may be disposed in a part of the first chamber that overlaps with the second chamber, and the tether may be connected across upper and lower parts of the tether hole at an inner surface of the tether hole.

The hanger may comprise: a column part fixed to the second chamber; and a head part with an expanded cross-section disposed at an end of the column part and configured to be caught by the tether.

A dome-shaped head part may be disposed at the end of the column part, and the diameter of a cross-section of the head part connected to the column part may be longer than a diameter of a cross-section of the column part.

A retention groove may be disposed on an outer side of the head part connected to the end of the column part.

The retention groove may be disposed in a plurality along a circumference of the head part with spacing below a predetermined angle.

The first chamber may overlap in front of the second chamber.

The second chamber may overlap in front of the first chamber.

The first chamber and the second chamber may be installed with different left and right positions based on a position in which a corresponding seat is arranged.

According to the present disclosure, the first chamber and the second chamber are deployed in a shape that entirely wraps around both sides and front of an occupant seated in a seat, thereby directly restraining occupants in various seat positions to respond to various collision modes, which has an effect of safely protecting occupants.

Moreover, the tether formed in the first chamber and the hanger formed in the second chamber are bound and fastened to each other, thereby restraining the occupant without relying on other structures inside the vehicle. Therefore, by restraining the occupant through self-binding of the airbag, there is an advantage of being able to quickly and safely restrain the occupant regardless of the vehicle interior.

Effects that can be obtained from the present disclosure are not limited to the effects mentioned above, and other effects not mentioned will be clearly understood by those skilled in the art to which the present disclosure belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a deployed configuration of the air bag device according to the present disclosure;

FIG. 2 is a view illustrating a first embodiment in which the first chamber and the second chamber according to the present disclosure are deployed;

FIG. 3 is a view showing a structure in which a tether is disposed in the first chamber according to the present disclosure;

FIG. 4 is a view showing a structure in which a hanger is disposed in the second chamber according to the present disclosure;

FIG. 5 is a view showing a configuration in which a plurality of hangers are fixed to a base plate according to the present disclosure;

FIG. 6 is a view for explaining the structure of the hanger according to the present disclosure;

FIG. 7 and FIG. 8 are views showing a configuration in which retention grooves are formed in the hanger according to the present disclosure;

FIGS. 9, 10, and FIG. 11 are views illustrating second to fourth embodiments in which the first chamber and the second chamber according to the present disclosure are deployed.

### DETAILED DESCRIPTION

Hereinafter, embodiments of the present disclosure will be described in detail with reference to the accompanying drawings, the same or similar elements are designated by the same reference numerals regardless of the numerals in the drawings, and redundant description thereof will be omitted.

In describing the embodiments disclosed in this specification, if it is determined that a detailed description of related known technology may obscure the gist of the embodiments disclosed in this specification, the detailed description thereof will be omitted. In addition, the accompanying drawings are only for easily understanding the embodiments disclosed in this specification, and the technical idea disclosed in this specification is not limited by the accompanying drawings, and should be understood to include all changes, equivalents, and substitutes included in the spirit and technical scope of the present disclosure. The following disclosure is not intended to limit the present disclosure to the described forms or specific fields, and it is considered that various alternative aspects and modifications to the present disclosure are possible, whether explicitly described or implied in this specification. Those skilled in the art to which the present disclosure belongs will recognize that the form and details of the present disclosure may be changed.

The present disclosure is described with reference to specific aspects. However, as understood by those skilled in the art to which the present disclosure belongs, various aspects disclosed in this specification may be modified or otherwise implemented in various other ways without departing from the spirit and scope of the present disclosure. Therefore, the following description should be considered as illustrative and is for the purpose of teaching those skilled in the art to which the present disclosure belongs how to make and use various embodiments. It will be understood that the forms of the disclosure shown and described in this specification will be taken as representative embodiments. Equivalent elements, or materials, processes or steps may be substituted for those representatively illustrated and described in the present disclosure. Expressions such as "including", "comprising", "incorporating", "consisting of", "have", "is", etc. used in describing the present disclosure should be interpreted in a non-exclusive manner, that is, allowing items, components or elements not explicitly described to be indicated. In addition, references to the singular should be interpreted to include the plural.

In addition, various embodiments disclosed in this specification should be taken in an illustrative and descriptive sense and should not be interpreted as limiting the content of the present disclosure. All references to joining (for example, attached, affixed, coupled, connected, etc.) are used only to aid understanding of the present disclosure and do not limit the position, direction or use of the configuration or the methods disclosed in this specification. Therefore, where joining references exist, they should be interpreted broadly. Moreover, in these joining references, it is not concluded that two or more elements are directly connected to each other. Additionally, all numerical terms, for example, "first", "second", "third", "primary", "secondary", "main" or any other general terms or numerical terms, should be taken only as identifiers to assist in understanding various components, forms, changes or modifications of the present disclosure, and do not mean limitations to any components, forms, changes or modifications or their order or preference. That is, these expressions may be used to describe various components, but the components are not limited by these expressions. These expressions are used only for the purpose of distinguishing one component from another component.

The suffixes "module" and "part" for components used in the following description are given or used interchangeably only for ease of specification writing, and do not have meanings or roles that are distinct from each other.

When a component is referred to as being "connected" to or "in contact with" another component, it should be understood that it may be directly connected to or in contact with the other component, but other components may exist in between. On the other hand, when a component is referred to as being "directly connected" to or "directly in contact with" another component, it should be understood that there are no other components in between.

In addition, the unit or control unit included in the name is merely a term widely used in naming control devices (controllers) that control specific functions of vehicles, and does not mean a generic function unit.

A controller may include a communication device that communicates with other controllers or sensors for control of responsible functions, memory that stores operating systems, logic commands, input/output information, etc., and one or more processors that perform judgments, calculations, decisions, etc. necessary for controlling responsible functions.

Any number of components or various components may be included in the disclosure described in this specification in any of the configurations described in this specification. Components may include any combination of features described in this specification and may be arranged in any of the various configurations described in this specification. Concepts regarding the structure and arrangement of components of the present disclosure as well as their use and operation may be applied to the specific embodiments discussed in this specification as well as any number of embodiments in any combination. Embodiments including those having various features of various arrangements are described below with reference to the drawings.

Hereinafter, various embodiments disclosed in this specification will be described in detail with reference to the accompanying drawings, and the same or similar components are given the same reference numbers regardless of the drawing symbols, and redundant description thereof will be omitted.

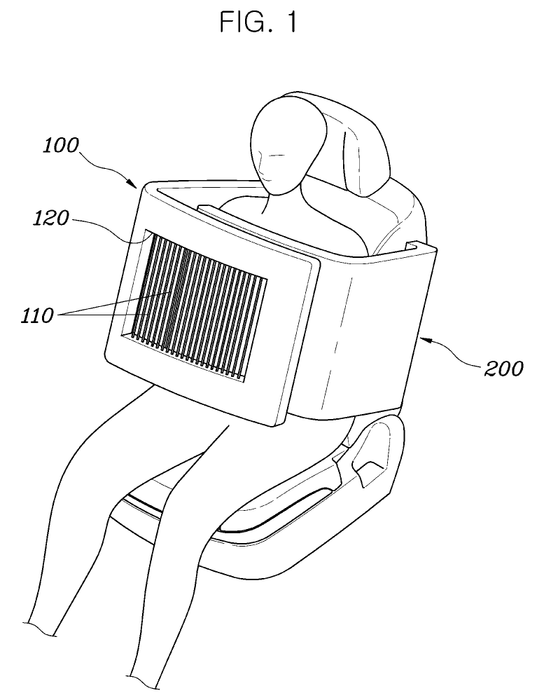

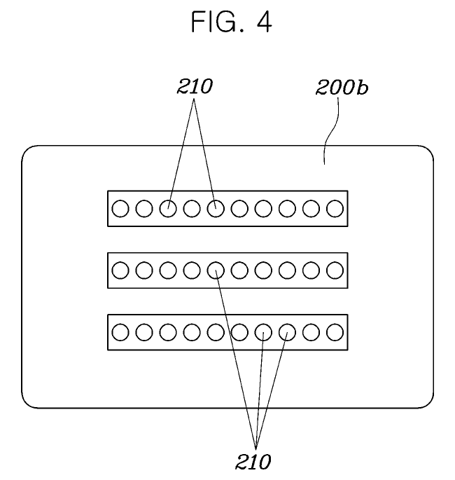

The air bag device of the present disclosure comprises: a first chamber 100 deployed in a shape that wraps around one side and front of an occupant, and provided with a tether 110 in a vertical length direction at a part that wraps around the front of the occupant; and a second chamber 200 deployed in a shape that wraps around another side and front of the occupant, wherein a part that wraps around the front of the occupant overlaps with the part of the first chamber 100 that wraps around the front of the occupant, and a hanger 210 is formed to protrude toward the tether 110 at a part overlapping with the first chamber 100 and is caught by the tether 110. Referring to FIG. 1 to FIG. 4, one end of the first chamber 100 is fixed to one side of the seatback and deployed toward the front, and one end of the second chamber 200 is fixed to another side of the seatback and deployed toward the front.

An intermediate part extending from one end to another end of the first chamber 100 is bent toward the second chamber 200 so that another end of the first chamber 100 is deployed in front of the occupant, and an intermediate part extending from one end to another end of the second chamber 200 is bent toward the first chamber 100 so that another end of the second chamber 200 is deployed in front of the occupant, whereby the first chamber 100 and the second chamber 200 are deployed in a shape that wraps around both sides and front of the occupant.

At this time, another end of the first chamber 100 and another end of the second chamber 200 deployed in front of the occupant are deployed in a form overlapping in front and rear directions.

In particular, the tether 110 is provided in a vertical length direction at a part of the first chamber 100 overlapping with the second chamber 200.

The tether 110 may be formed as a relatively thin and long string or band shape.

The hanger 210 is formed to protrude toward the tether 110 at a part of the second chamber 200 overlapping with the first chamber 100.

The hanger 210 is formed in a shape capable of being caught by the tether 110 and binding.

That is, as the first chamber 100 and the second chamber 200 are deployed in a shape that wraps around both sides of the occupant, the hanger 210 is caught by the tether 110 and fastened in front of the occupant, whereby the first chamber 100 and the second chamber 200 are deployed in a shape that entirely wraps around both sides and front of an occupant seated in the seat 20.

Therefore, by directly restraining occupants in various seat positions, it is possible to respond to various collision modes to safely protect occupants, and it is possible to replace other airbags as well as seat belts, greatly improving marketability.

In particular, the tether 110 formed in the first chamber 100 and the hanger 210 formed in the second chamber 200 are bound and fastened to each other, thereby restraining the occupant without relying on other structures inside the vehicle. Therefore, by self-binding of the airbag to restrain the occupant, it is possible to quickly and safely restrain the occupant regardless of the vehicle interior.

In addition, the first chamber 100 is configured to include a first side part 100a and a first front part 100b, and the second chamber 200 is configured to include a second side part 200a and a second front part 200b.

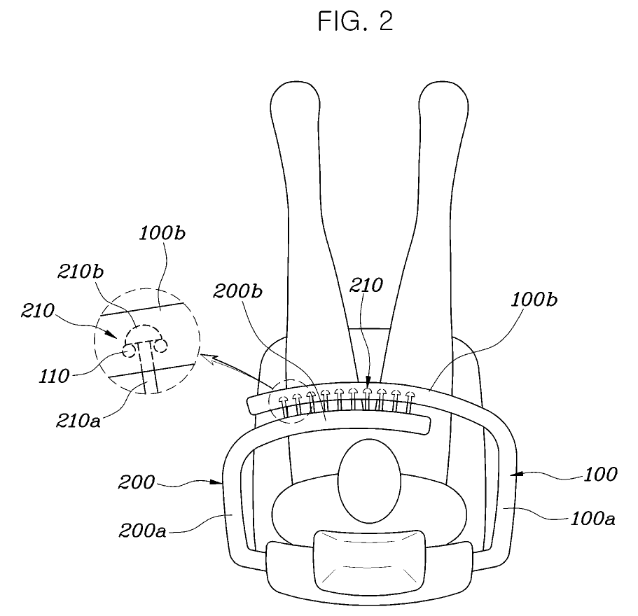

Referring to FIG. 1 and FIG. 2, the first chamber 100 comprises: a first side part 100a deployed forward from one side of the seat to cover one side of the occupant; a first front part 100b bent toward the front of the seat from a front end of the first side part 100a to cover the front of the occupant.

The second chamber 200 comprises: a second side part 200a deployed forward from another side of the seat to cover another side of the occupant; a second front part 200b bent toward the front of the seat from a front end of the second side part 200a to cover the front of the occupant while overlapping with the first front part 100b.

For example, a rear end of the first side part 100a is fixed to one side of a seatback frame provided inside the seatback 22, and a front end of the first side part 100a is deployed toward the front to cover one side of the occupant.

A front end of the first front part 100b is connected to one end of the first side part 100a, and another end of the first side part 100a is deployed in a direction perpendicular toward another side of the seat 20, so that the first chamber 100 is deployed in an 'L' shape.

In addition, a rear end of the second side part 200a is fixed to another side of the seatback frame provided inside the seatback 22, and a front end of the second side part 200a is deployed toward the front to cover another side of the occupant.

A front end of the second front part 200b is connected to one end of the second side part 200a, and another end of the second side part 200a is deployed in a direction perpendicular toward another side of the seat 20, so that the second chamber 200 is deployed in an 'L' shape.

The second front part 200b is deployed in a form overlapping in front of or behind the first front part 100b.

For reference, in a structure in which the second front part 200b is deployed in a form overlapping behind the first front part 100b, a front-rear length of the first side part 100a should be formed longer than a front-rear length of the second side part 200a.

Furthermore, in the present disclosure, the first chamber 100 and the second chamber 200 may be deployed with a time difference.

For this purpose, inflators that inject gas into the first chamber 100 and the second chamber 200 may be provided individually, and may be implemented by controlling the ignition timing of each inflator differently.

For example, the second chamber 200 may be deployed before the first chamber 100, or the first chamber 100 may be deployed before the second chamber 200, but preferably, the second chamber 200 may be deployed before the first chamber 100.

That is, as the second chamber 200 is deployed and the hanger 210 protrudes toward the first chamber 100, when the first chamber 100 is deployed, the tether 110 is caught by the protruding hanger 210, whereby the tether 110 can be stably and easily caught by the hanger 210.

In the present disclosure, the tether 110 and the hanger 210 may be arranged in a plurality side by side with spacing in a left-right direction.

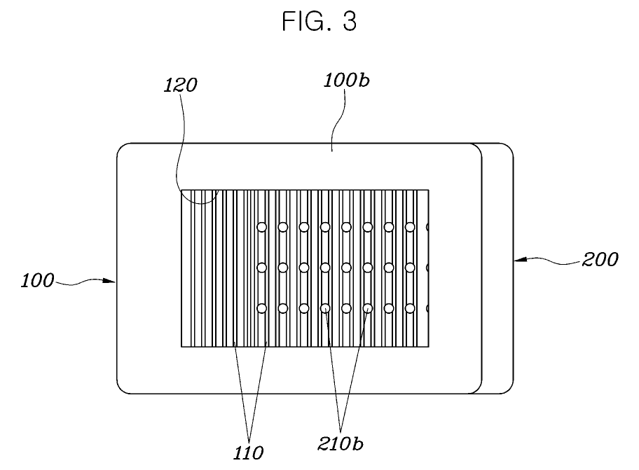

Referring to FIG. 3 to FIG. 5, a plurality of tethers 110 may be arranged at equal intervals along the left-right direction in the middle of the first front part 100b.

A plurality of hangers 210 may be arranged at equal intervals along the left-right direction in the middle of the second front part 200b.

Each hanger 210 may be fixed in a row to one surface of a plate-shaped base plate 220, and another surface of the base plate 220 may be sewn and fixed to the second front part 200b.

At this time, the hangers 210 and the tethers 110 are arranged with the same spacing, so that different tethers 110 can be caught by each hanger 210.

Therefore, different tethers 110 are simultaneously caught with the same resistance force by each hanger 210, thereby strengthening the binding force between the tethers 110 and the hangers 210 to more safely restrain the occupant.

For reference, a plurality of hangers 210 spaced left and right may be arranged in multiple rows along the up-down direction, and all hangers 210 arranged in each row may be caught by the tethers 110, thereby further strengthening the binding force between the hangers 210 and the tethers 110.

In addition, in the present disclosure, a tether hole 120 is formed in a part of the first chamber 100 overlapping with the second chamber 200; and the tether 110 may be connected across upper and lower parts at an inner surface of the tether hole 120.

Referring to FIG. 1 and FIG. 3, the tether hole 120 is formed in a rectangular window shape in the middle of the first front part.

An upper end of the tether 110 is connected to an upper inner surface of the tether hole 120, and the tether 110 crosses the tether hole 120 so that a lower end of the tether 110 is connected to a lower inner surface of the tether hole 120.

In this way, as the tether 110 is connected within the tether hole 120, the hanger 210 enters between the tethers 110 as if penetrating the inside of the tether hole 120, whereby the tether 110 can be smoothly caught by the hanger 210.

Furthermore, the hanger 210 comprises: a column part 210a fixed to the second chamber 200; a head part 210b formed with an expanded cross-section at an end of the column part 210a and caught by the tether 110.

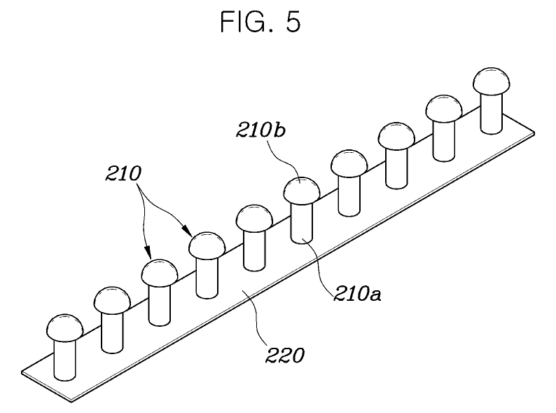

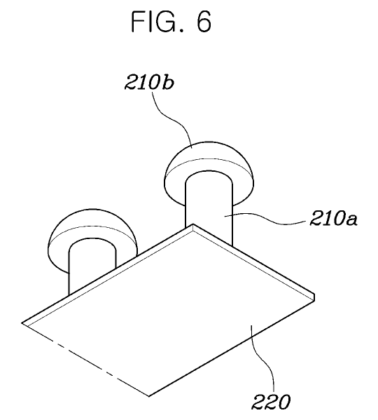

Referring to FIG. 5 and FIG. 6, the hanger 210 can be manufactured from materials such as polyurethane and polyvinyl chloride, the column part 210a is formed in a cylindrical shape so that a lower end of the column part 210a is fixed to the base plate 220, and the base plate 220 is fixed to the second front part 200b so that the column part 210a can be fixed to the second chamber 200.

The head part 210b is integrally formed at an upper end of the column part 210a.

In particular, the head part 210b fixed to the column part 210a is expanded to a cross-section wider than the cross-sectional area of the column part 210a.

Therefore, the tether 110 is caught by the head part 210b with an expanded cross-section, whereby the tether 110 can be bound to the hanger 210.

Furthermore, a dome-shaped head part 210b is formed at an end of the column part 210a; and a diameter of a cross-section of the head part 210b connected to the column part 210a is formed longer than a diameter of a cross-section of the column part 210a and is caught by the tether 110.

That is, as a diameter of the head part 210b fixed to the column part 210a is formed larger than a diameter of the column part 210a, the tether 110 is caught by the head part 210b connected to the column part 210a.

In addition, in the present disclosure, a retention groove 211 may be formed on an outer side of the head part 210b connected to an end of the column part 210a.

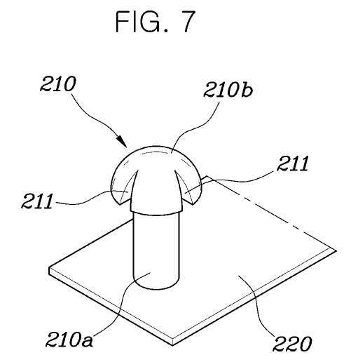

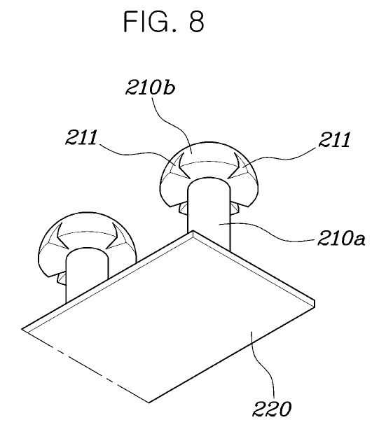

Referring to FIG. 7 and FIG. 8, the retention groove 211 may be formed in a notch shape having a 'V'-shaped cross-section at an outer edge of the head part 210b.

A maximum circumferential length of the retention groove 211 may be formed to be at least larger than a thickness of the tether 110.

Accordingly, as the tether 110 is caught by the expanded head part 210b and fitted into the retention groove 211 formed in the head part 210b, the binding force between the tether 110 and the hanger 210 can be further strengthened.

Furthermore, the retention groove 211 may be formed in a plurality along a circumference of the head part 210b with spacing below a predetermined angle.

Preferably, the retention groove 211 may be formed at equal angles with 90° spacing along a circumferential direction of the head part 210b.

Of course, an angle between the retention groove 211 and another neighboring retention groove 211 may be formed to be 90° or less, and angles between each retention groove 211 may be formed at unequal angles.

Meanwhile, in the present disclosure, the first chamber 100 may be configured to overlap in front of the second chamber 200.

Referring to FIG. 2, the second front part 200b of the second chamber 200 is deployed in front of the occupant, and the first front part 100b of the first chamber 100 is deployed overlapping in front of the second front part 200b.

At this time, the tether 110 is fixed to the first front part 100b positioned in front, and the hanger 210 is fixed to the second front part 200b positioned behind toward the tether 110 in front, so that the tether 110 is caught by the hanger 210.

As another example, the second chamber 200 may be configured to overlap in front of the first chamber 100.

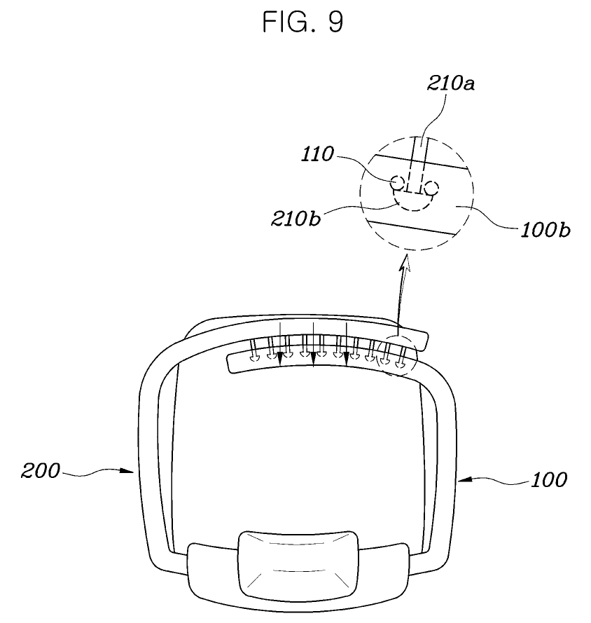

Referring to FIG. 9, the first front part 100b of the first chamber 100 is deployed in front of the occupant, and the second front part 200b of the second chamber 200 is deployed overlapping in front of the first front part 100b.

At this time, the tether 110 is fixed to the first front part 100b positioned behind, and the hanger 210 is fixed to the second front part 200b positioned in front toward the tether 110 behind, so that the tether 110 is caught by the hanger 210.

As another example, the first chamber 100 and the second chamber 200 may be installed with different left and right positions based on a position where a corresponding seat is arranged.

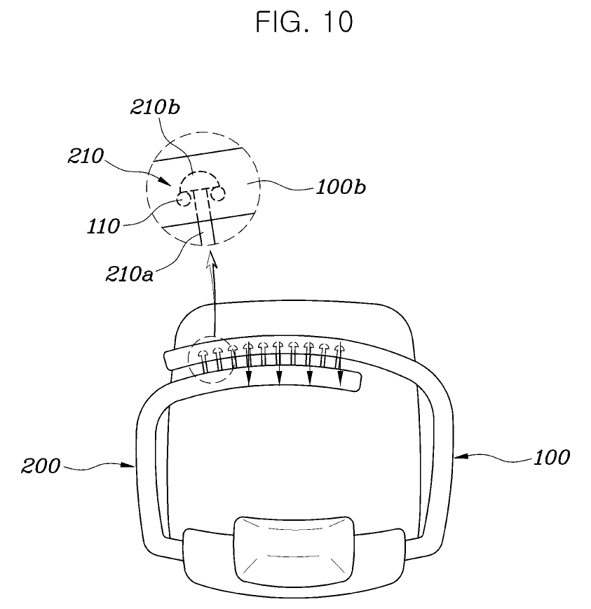

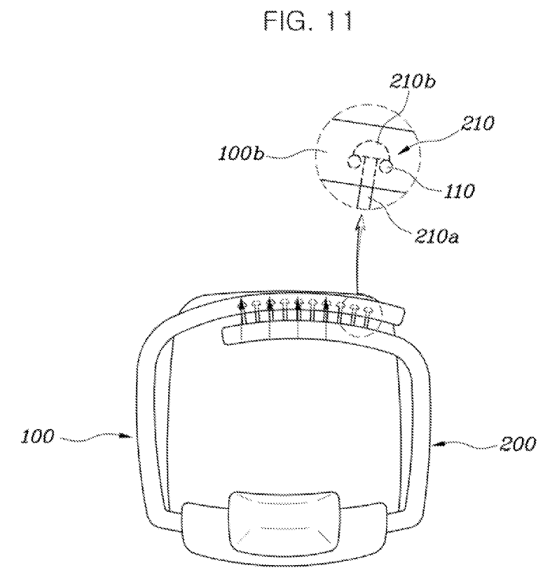

Referring to FIG. 10 and FIG. 11, according to the arrangement of seats, the first chamber 100 may be deployed from the left side of the seat, and the second chamber 200 may be deployed from the right side of the seat.

In addition, the second chamber 200 may be deployed from the left side of the seat, and the first chamber 100 may be deployed from the right side of the seat.

In all of these embodiments, the tether 110 is fixed to the first chamber 100, and the hanger 210 is fixed to the second chamber 200 toward the tether 110, whereby the tether 110 can be caught by the hanger 210.

In this way, according to the present disclosure, the first chamber 100 and the second chamber 200 are deployed in a shape that entirely wraps around both sides and front of an occupant seated in a seat, thereby directly restraining occupants in various seat positions to respond to various collision modes, which safely protects occupants.

In particular, the tether 110 formed in the first chamber 100 and the hanger 210 formed in the second chamber 200 are bound and fastened to each other, thereby restraining the occupant without relying on other structures inside the vehicle. Therefore, by self-binding of the airbag to restrain the occupant, it is possible to quickly and safely restrain the occupant regardless of the vehicle interior.

Although shown and described with respect to specific embodiments of the present disclosure, it is obvious to those skilled in the art that the disclosure may be variously improved and changed within the scope that does not depart from the technical spirit of the present disclosure provided by the following claims.

What is claimed is:

1. An air bag device comprising:
a first chamber configured to be deployed in a shape that wraps around a first side and front of an occupant, the first chamber including a tether disposed in a vertical length direction at a part of the first chamber that wraps around the front of the occupant; and
a second chamber configured to be deployed in a shape that wraps around a second side and the front of the occupant, wherein a part of the second chamber that wraps around the front of the occupant overlaps with the part of the first chamber that wraps around the front of the occupant, the second chamber including a hanger that protrudes toward the tether at a part of the second chamber that overlaps with the first chamber and is configured to be caught by the tether.

2. The air bag device according to claim 1, wherein the first chamber comprises:
a first side part configured to be deployed forward from a first side of a seat to cover the first side of the occupant; and
a first front part bent toward a front of the seat from a front end of the first side part to cover the front of the occupant, and
wherein the second chamber comprises:
a second side part configured to be deployed forward from a second side of the seat to cover the second side of the occupant; and
a second front part bent toward the front of the seat from a front end of the second side part to cover the front of the occupant while overlapping with the first front part.

3. The air bag device according to claim 1, wherein the first chamber and the second chamber are configured to be deployed at different times.

4. The air bag device according to claim 1, wherein the tether and the hanger are disposed in a plurality side by side with spacing in a left-right direction.

5. The air bag device according to claim 1, wherein a tether hole is disposed in a part of the first chamber that overlaps with the second chamber, and
wherein the tether is connected across upper and lower parts of the tether hole at an inner surface of the tether hole.

6. The air bag device according to claim 1, wherein the hanger comprises:
a column part fixed to the second chamber; and
a head part with an expanded cross-section disposed at an end of the column part and configured to be caught by the tether.

7. The air bag device according to claim 6, wherein a dome-shaped head part is disposed at the end of the column part, and
wherein a diameter of the cross-section of the head part connected to the column part is longer than a diameter of a cross-section of the column part.

8. The air bag device according to claim 6, wherein a retention groove is disposed on an outer side of the head part connected to the end of the column part.

9. The air bag device according to claim 8, wherein the retention groove is disposed in a plurality along a circumference of the head part with spacing below a predetermined angle.

10. The air bag device according to claim 1, wherein the first chamber overlaps in front of the second chamber.

11. The air bag device according to claim 1, wherein the second chamber overlaps in front of the first chamber.

12. The air bag device according to claim 1, wherein the first chamber and the second chamber are installed with different left and right positions based on a position in which a corresponding seat is arranged.
